(19) United States
(12) Patent Application Publication
(10) Pub. No.: US 2010/0270764 A1
(43) Pub. Date: Oct. 28, 2010

(54) Adaptable Rugged Terrain Cart

(76) Inventors: Kirtland Louis Odle, Hendersonville, TN (US); Keith Preston Odle, Hendersonville, TN (US)

Correspondence Address: Kirtland L. Odle, 114 Millbrook Road, Hendersonville, TN, 37075, US

(21) Appl. No.: 12/430,341

(22) Filed: Apr. 27, 2009

(51) Int. Cl. B62B 1/12

(52) U.S. Cl. 280/47.19; 280/47.31; 280/47.315; 280/727

(57) ABSTRACT

The current invention is a non motorized cart for use on rugged terrain, operated by one or more persons, comprising a single wheel with a brake attached to the wheel housing of a rigid frame. The frame additionally comprises a posteriorly positioned primary steering and lifting handgrip, and an anteriorly positioned supplementary assistance lifting handgrip. The frame additionally provides multiple detachable connections for various interchangeable load bearing platforms, which can be easily interchanged in the field, without tools. The frame additionally provides an attachment point for supplemental sources of motive power. Additional features include an electronic odometer and a self contained electrical storage system.

### BACKGROUND OF THE INVENTION

Numerous examples exist of similar single wheeled carts intending to ease the burden of transporting relatively heavy equipment, provisions, etc. over hiking trails and other rugged terrain. Among these are U.S. Pat. Nos. 3,456,959 to Thomas Hemphill; 4,055,354 to Donald M. Sharpe; 4,063,744 to Charles Fraser; 4,171,139 to Edwin Cockram; 4,444,405 to Dwight Barrus; and 4,869,517 to Philip Smith.

These patents disclose devices utilizing a single wheel, and which employ various fixed, generic load bearing surfaces, and are equipped with a variety of handles, harnesses and yoke attachments used to facilitate propelling and maneuvering the vehicles along rugged terrain by one or two persons. A shared central design feature among these examples is the positioning of the load so as to continuously balance the center of mass vertically above the axle of the wheel thereby minimizing the amount of effort on the part of the operator while in use, and so allowing the device to perform extremely tight turns, including a zero radius turn, or pivot.

Other examples of load bearing devices intended for rugged terrain, of less similar design and more resembling traditional wheel barrows, either pushed ahead of, or pulled behind, the primary operator, do not allow for the continuous bearing of the load vertically above the center of the bearing axle of the wheel(s), thereby requiring the operator to lift or bear a significant portion of the dead weight of the load, in addition to applying motive and steering forces to convey the load. Such devices employ either a single wheel or a set of dual wheels. Examples of this type can be seen in U.S. Pat. Nos. 5,385,355 to James Hoffman; 6,139,033 to David Western; 6,203,033 to Bryce Knoll; 6,341,787 to Gordon Mason; 6,685,198 to Donald Hartman; and 6,039,333 to Steven Hamblin.

Further examples of less similar devices which do completely bear the dead weight of the load, but require multiple wheels oriented as an inline pair to do so, can be seen in U.S. Pat. Nos. 6,811,179 to Charles Woods and 5,556,117 to George Szeremeta.

Among the most similar examples of cited prior art, Hemphill and Smith's designs both completely forgo provision of structures to allow a second person to assist in lifting or conveying the vehicle. All similar prior art designs forgo the provision of a third or additional persons to assist in conveying the vehicle. All similar prior art designs forgo the provision to attach non-human sources of motive power, such as a dog team, small pack animal, etc.

All similar examples of prior art feature either; [1] a single, fixed configuration of generic, non-specialized load bearing surfaces, platforms and fixtures, or [2] a single, fixed configuration of a highly specialized load bearing platform, surface or fixture, intended specifically for a single type of load contents, to the exclusion of other types. In either case, the prior art is designed without the ability to interchange, alter, or otherwise significantly reconfigure the orientation and nature of their respective load bearing surfaces, platforms and fixtures, thereby precluding the ability of each vehicle's design to adapt to widely differing load contents and conditions, and so reducing their overall usefulness.

All prior art vehicles employing multiple wheels, such as dual wheels being laterally oriented, as seen in Hamblin, are inherently less able to remain vertically oriented on trail surfaces that are not level, requiring additional exertion from the operator to keep the vehicle upright and the load intact. All prior art vehicles employing dual wheels that are sequentially oriented, that is, an inline front and a rear wheel, as seen in Woods, suffer from the inability to turn sharply, or pivot on a single point, to the left or right, and so are less able to negotiate acutely angled turns, often at steep grades, which are common on trails. Both orientations of dual wheeled vehicles reduce the maneuverability of the examples, and increase the exertion required by the operator(s) while conveying the load, as well as increasing the possibility for slipping, falling, and tipping over, thereby risking injury to the operator, or damage to the load contents.

The current invention successfully integrates all optimized aspects of design for ease of use under load, by balancing the center of mass vertically above the single wheel's axle thereby minimizing the effort required to lift the dead load weight, by maximizing maneuverability on narrow, pitched and winding terrain, by allowing the quick and easy attachment of, and detachment of, additional sources of motive power, and by providing the ability to quickly and easily change, alter or reconfigure the load bearing platforms, surfaces and fixtures, thereby increasing the flexibility of the vehicle in adapting to a wide variety of load contents, conditions and requirements.

### BRIEF SUMMARY OF THE PRESENT INVENTION

The invention relates to a non motorized, single wheeled vehicle, or cart, used by one or more persons to easily transport heavy equipment and provisions to be used in remote locations, requiring traversal over rugged, narrow, winding, steep and uneven terrain, such as a trail.

The present invention comprises a cart, or vehicle, having a single wheel equipped with a treaded tire, supporting a light weight, yet very rigid frame, which is easily and comfortably propelled by one or more persons over long distances of pitched, narrow, rugged or uneven terrain, such as a hiking trail. The design of the vehicle minimizes the vertical height of the center of mass of the load, optimizes ground clearance and width, and balances the center of mass of the load vertically above the axle of the wheel, thereby making the vehicle highly maneuverable and stable under load. The primary operator conveys the vehicle by way of pushing forward on a set of adjustable handlebars mounted at the rear, or back, position. To navigate obstacles blocking the path, ford creeks, or otherwise traverse surfaces over which the wheel is ineffective, a retractable front mounted supplemental boom allows a second person to assist the operator in lifting and carrying the vehicle. An attachment point coupling allows connection of various sources of supplemental motive power while minimizing the induction of lateral forces. An integral, highly efficient brake allows the operator to variably retard or completely halt the vehicle while in motion, or lock the brake for parking on steep grades. Easily interchangeable modular load bearing platform and fixture assemblies allow the capacity and configuration of the vehicle to be altered quickly without tools, thereby allowing the vehicle to easily adapt to the requirements of the loads to be transported. The axle and wheel assembly may be mounted to the frame in either a fixed rigid, or a decoupled, compressionally loaded manner. The vehicle may also be equipped with an accurate odometer, and an integral rechargeable electrical system capable of receiving, storing, and supplying AC or DC power to support a variety of communication, computing, navigation or other electronic equipment and tools.

### BRIEF DESCRIPTION OF ILLUSTRATIONS

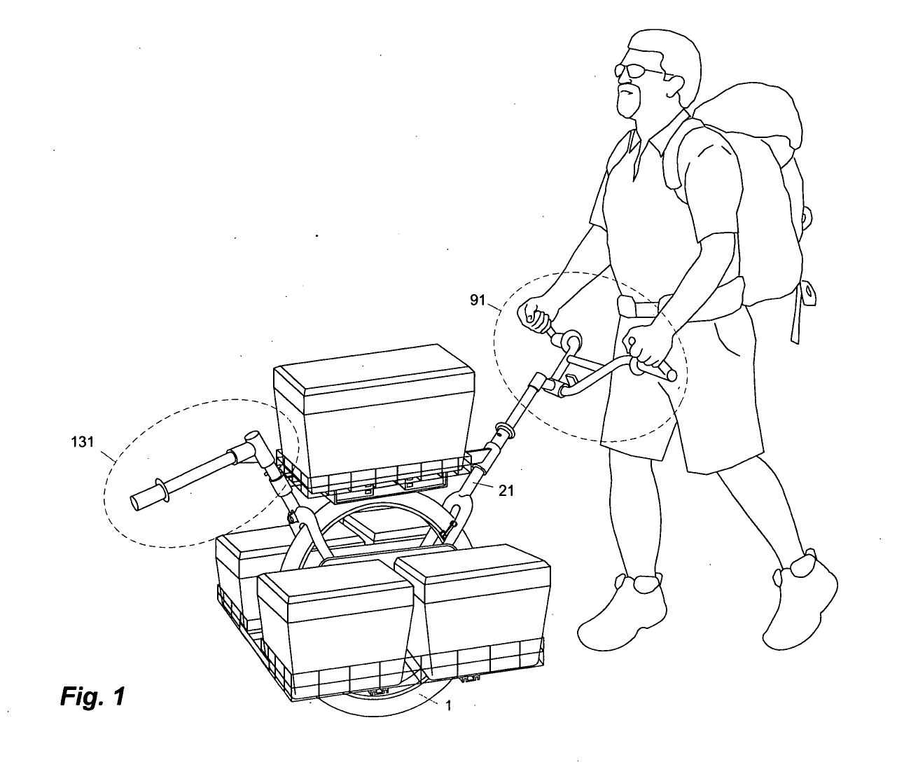

FIG. 1. Perspective view of primary operator pushing one embodiment of the present invention.

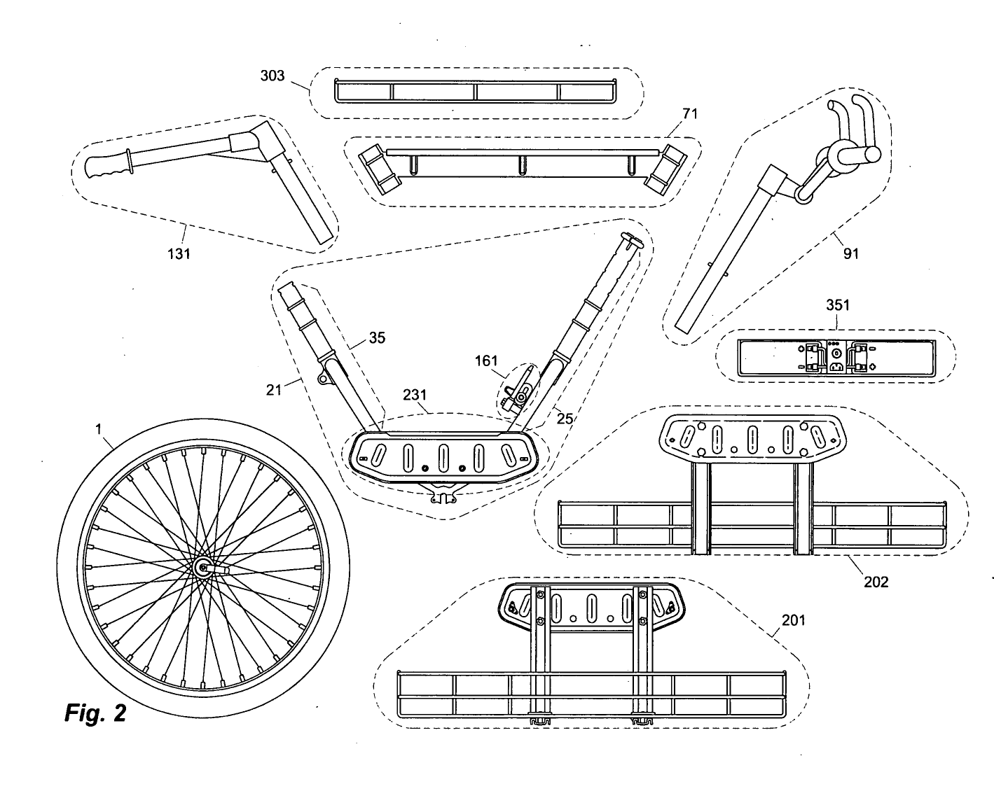

FIG. 2. Exploded view of major component assemblies of one embodiment of the present invention.

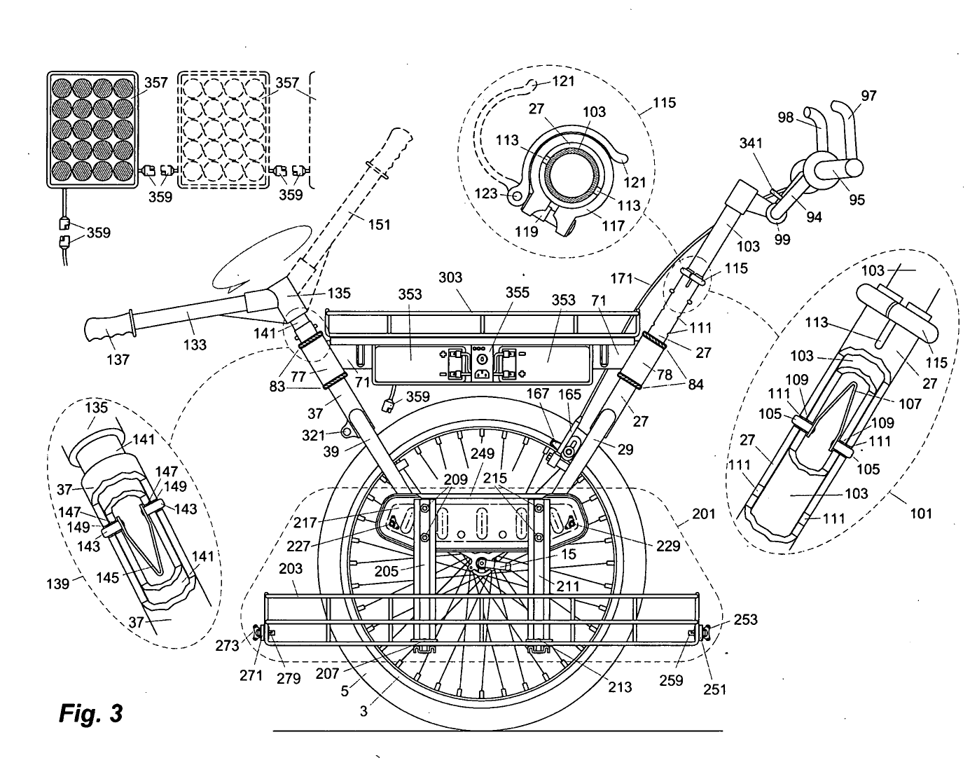

FIG. 3. Left lateral elevation view of one embodiment of the present invention.

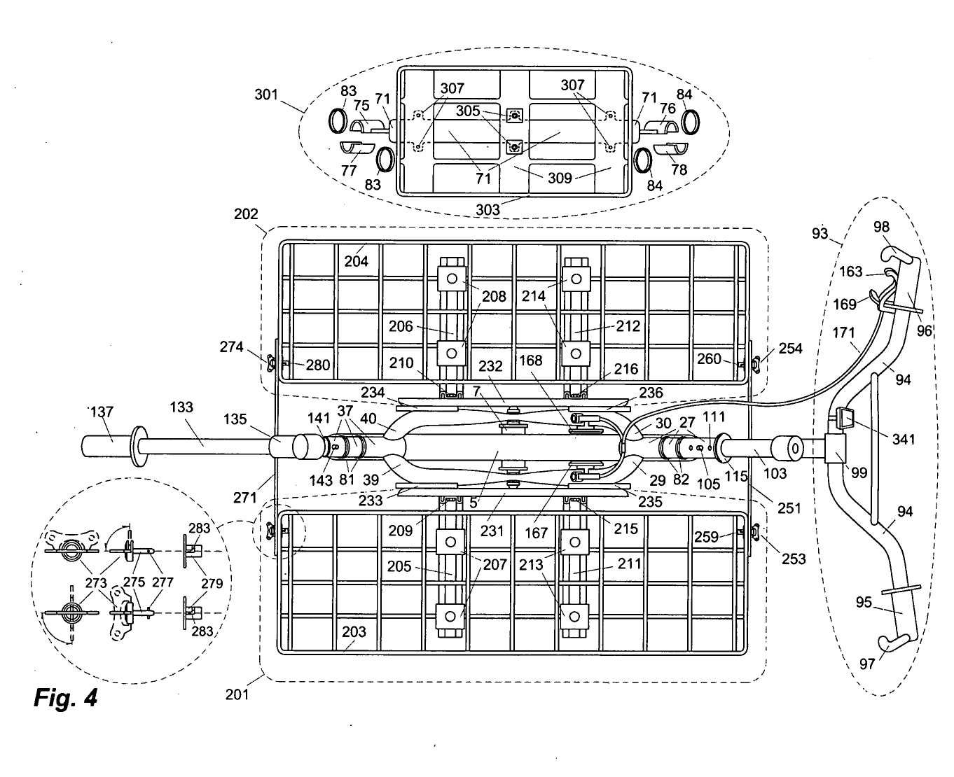

FIG. 4. Top plan view of one embodiment of the present invention.

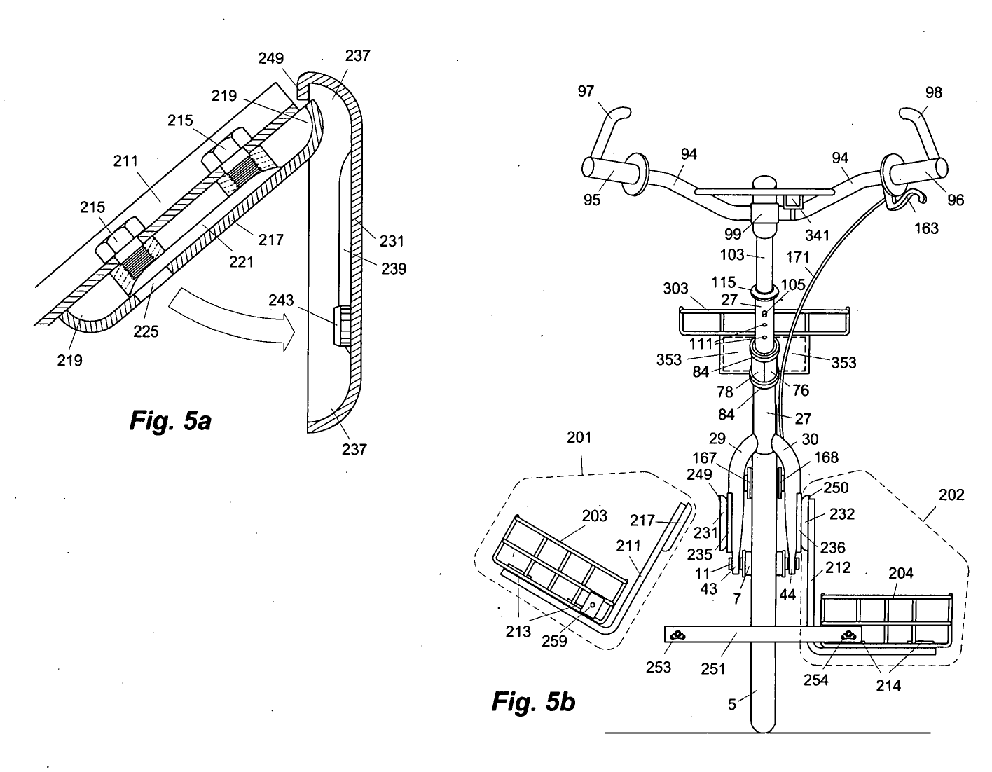

FIG. 5a. Rear elevation section detailing engagement process of side load platform coupler hanger and receiver brackets of one embodiment of the present invention.

FIG. 5b. Rear elevation view of one embodiment of the present invention detailing removable side load platform assembly.

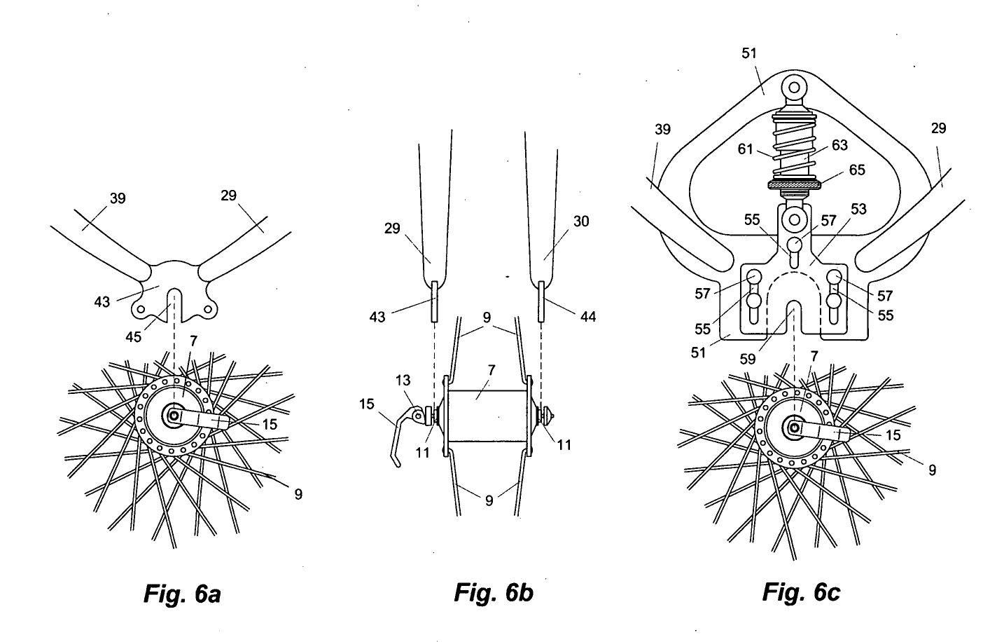

FIG. 6a. Left side lateral elevation view of rigid axle attachment to frame.

FIG. 6b. Rear elevation view of rigid axle attachment to frame.

FIG. 6c. Left side lateral elevation view of decoupled and compressionally loaded axle attachment to frame.

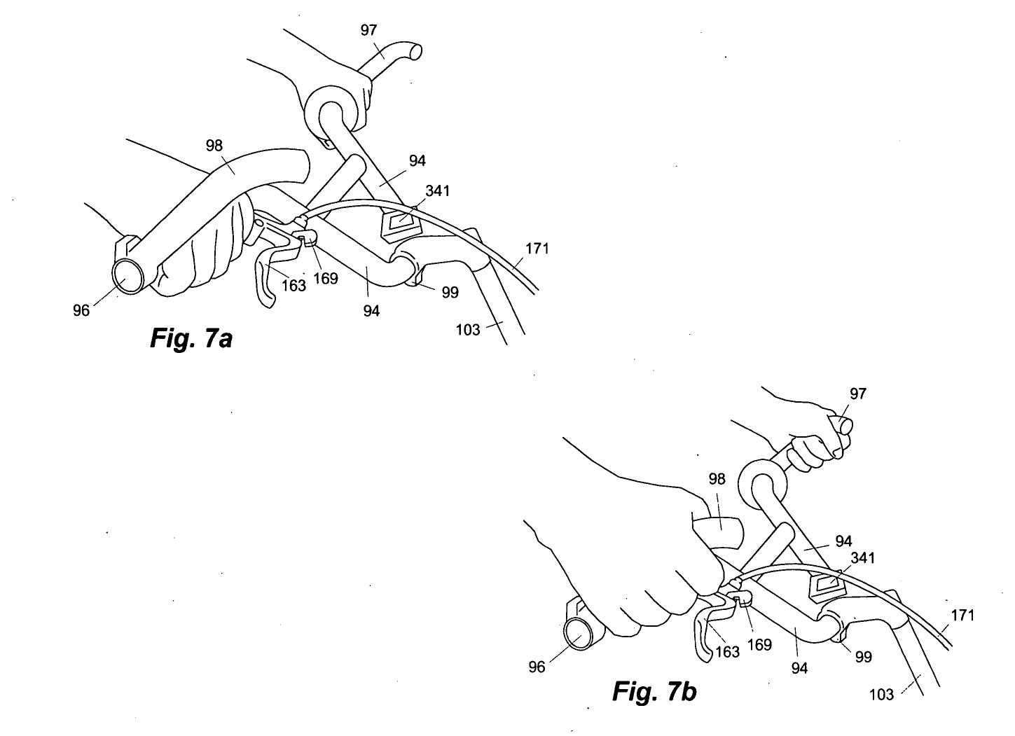

FIG. 7a. Detail of operator's hand grip in primary ergonomic position.

FIG. 7b. Detail of operator's hand grip in alternate ergonomic position.

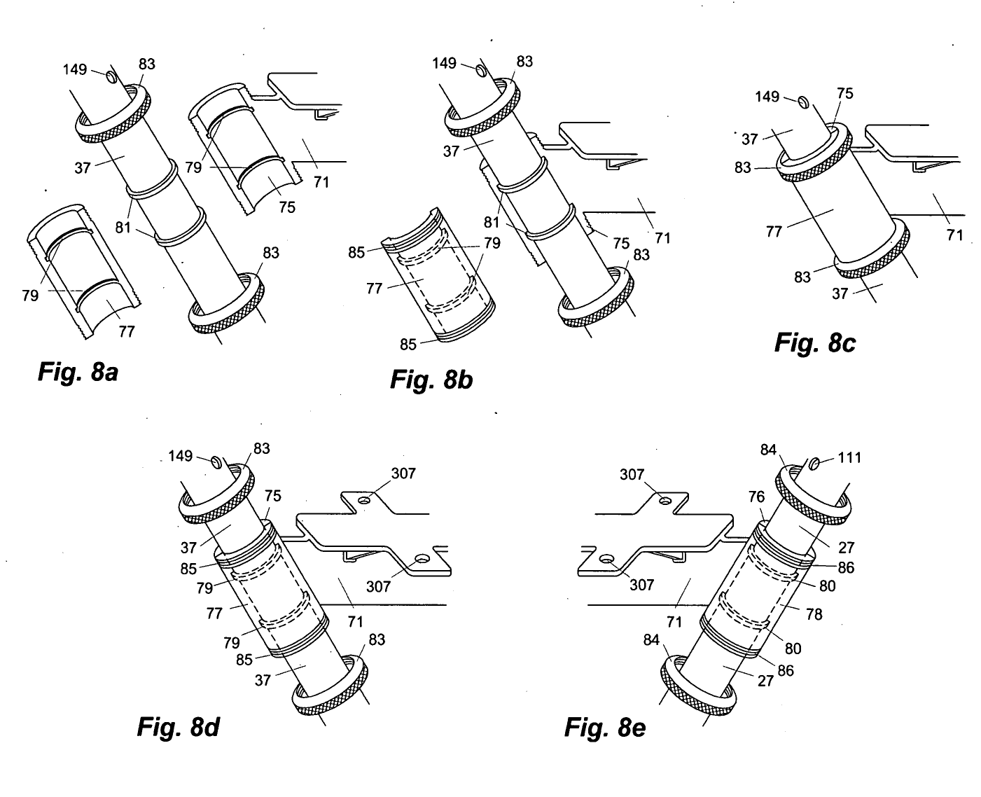

FIGS. 8a-8e. Perspective views illustrating the sequence of engagement for one embodiment of the upper horizontal frame member.

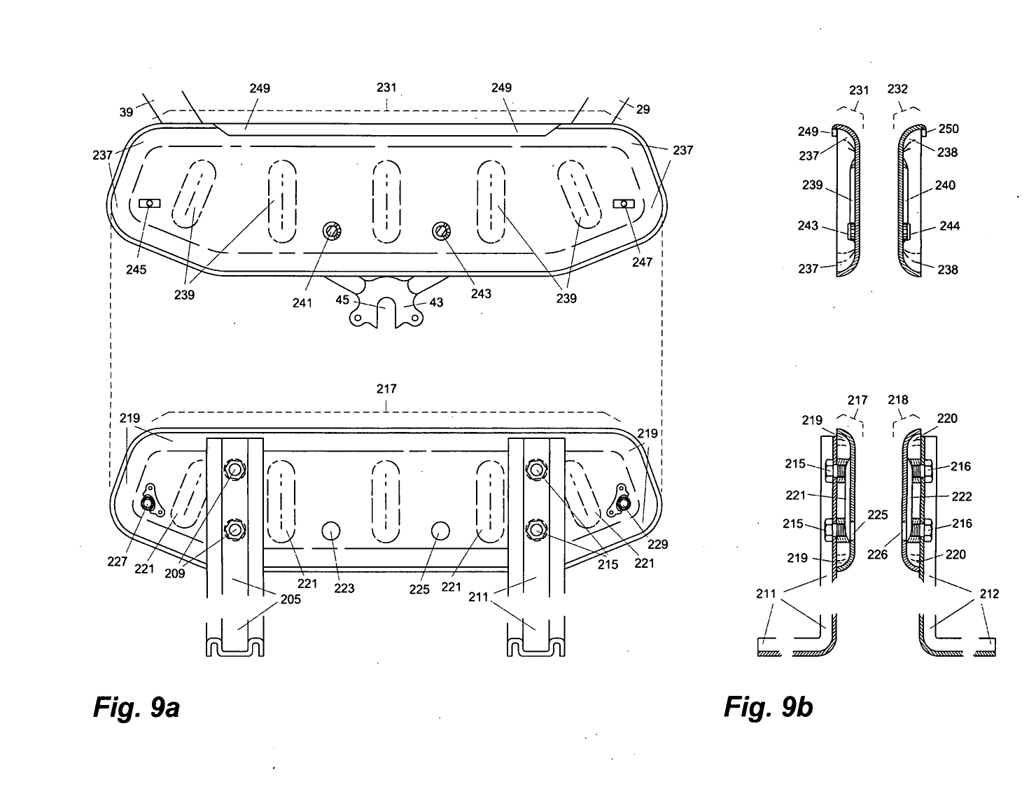

FIG. 9a. Lateral elevation view of one embodiment of a side mounting platform coupler detailing the hanger and receiver brackets.

FIG. 9b. End section elevation view of a side mounting platform coupler detailing the hanger and receiver brackets.

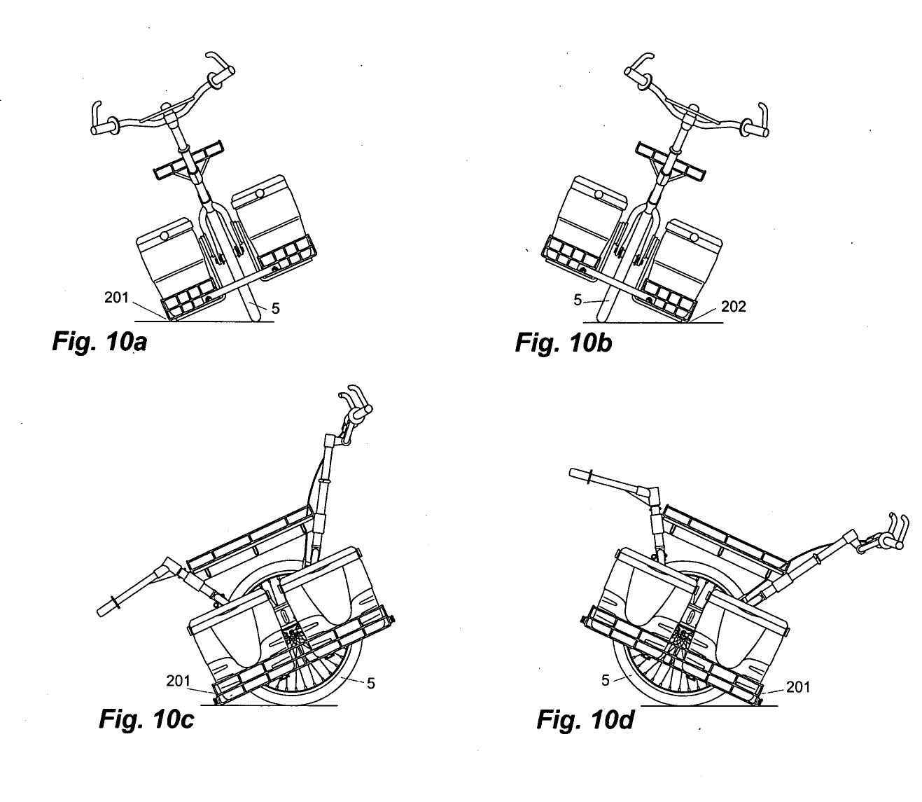

FIG. 10a-10d. Rear and lateral elevation views showing stable positions of invention while parked.

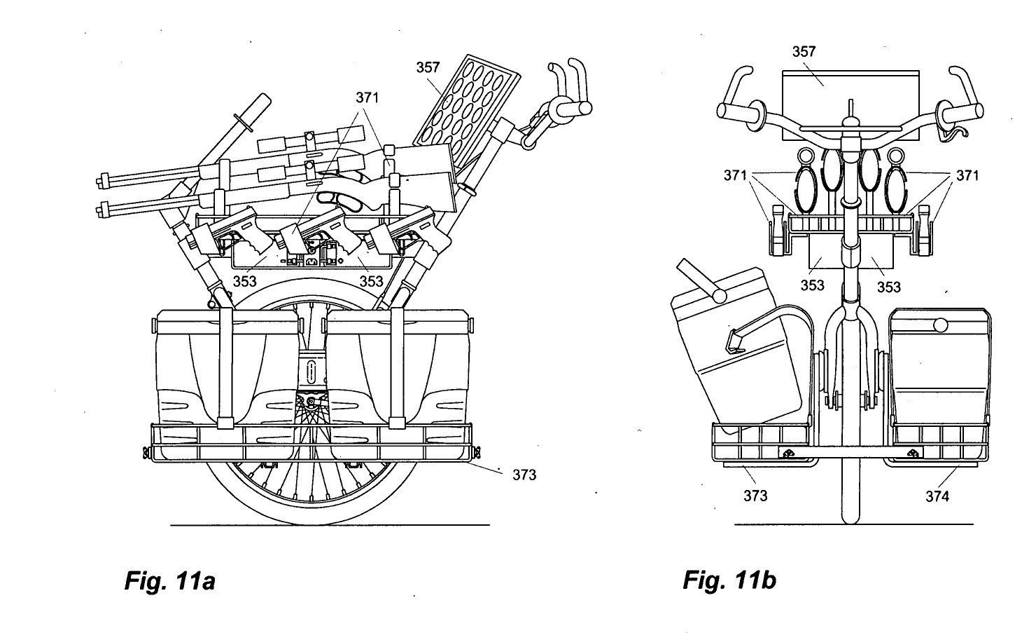

FIG. 11a. Lateral elevation view with implementation of specialized load platforms for ice chests and firearms.

FIG. 11b. Rear elevation view with implementation of specialized load platforms for ice chests and firearms.

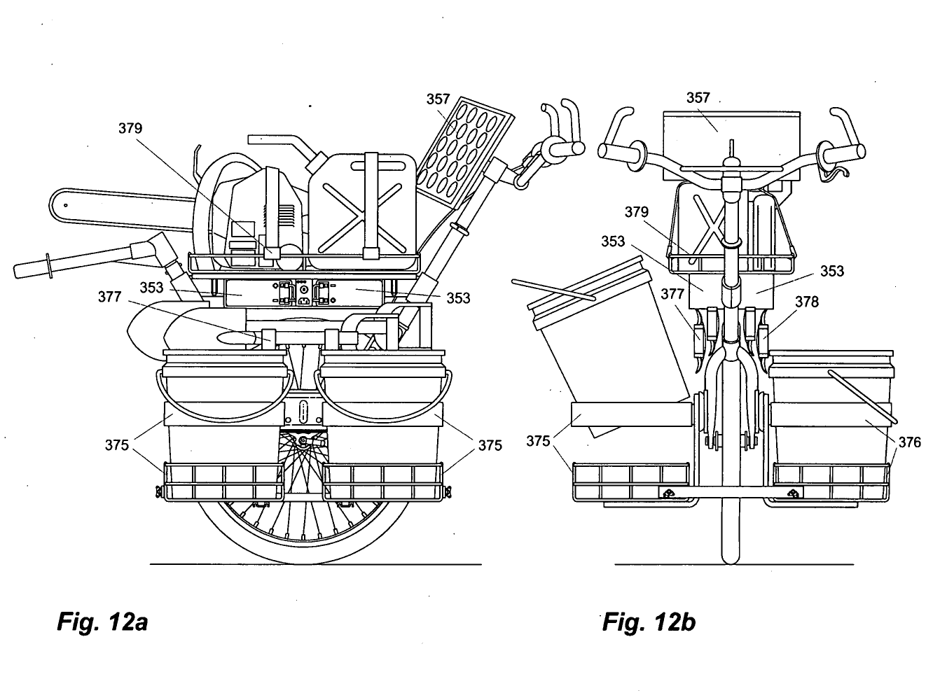

FIG. 12a. Lateral elevation view with implementation of specialized load platforms for plastic 5 gallon containers & trail maintenance tools.

FIG. 12b. Rear elevation view with implementation of specialized load platforms for plastic 5 gallon containers & trail maintenance tools.

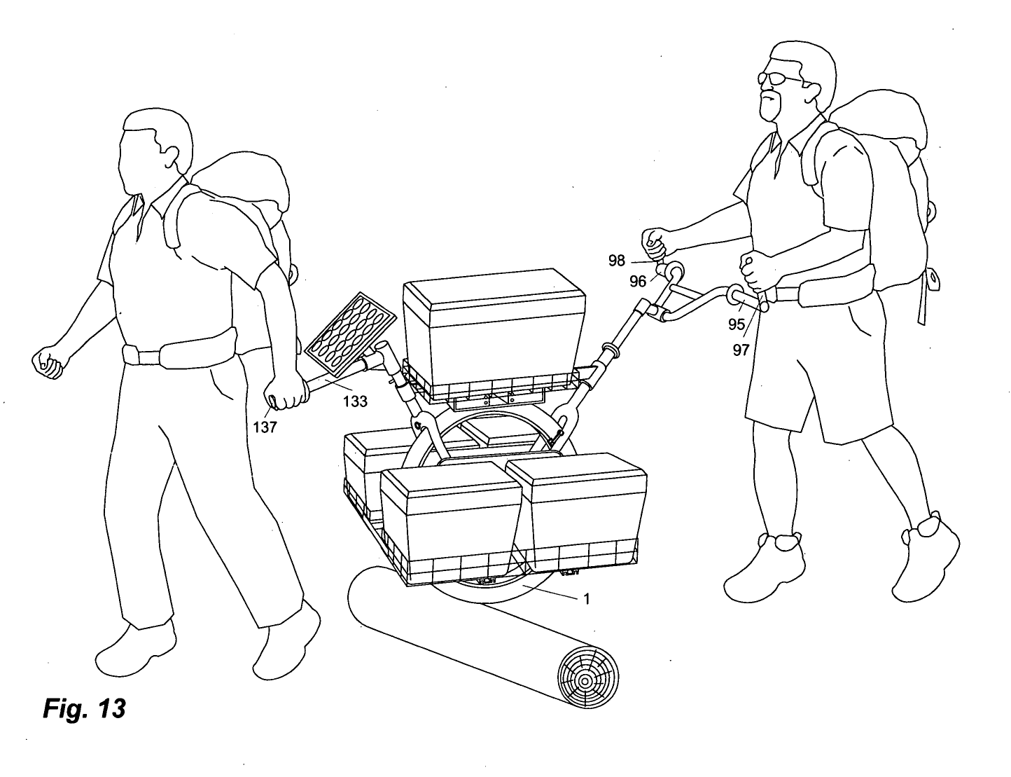

FIG. 13. Perspective view of second person helping lift one embodiment of the present invention over obstruction using deployed front portage boom.

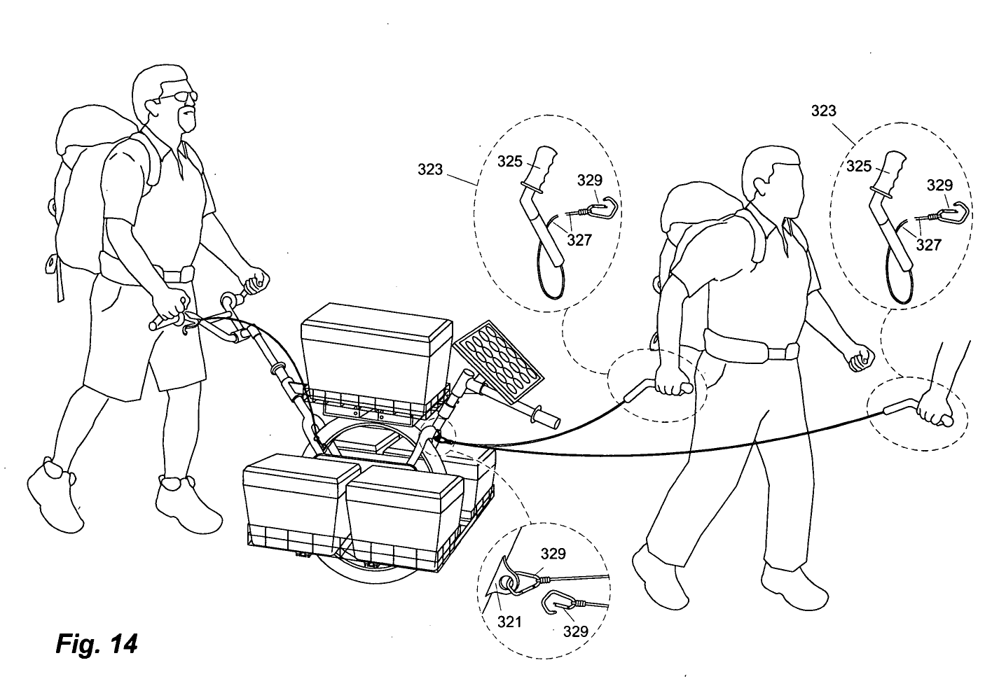

FIG. 14. Perspective view of optional second & third persons helping pull one embodiment of the present invention using quick disconnect lanyards.

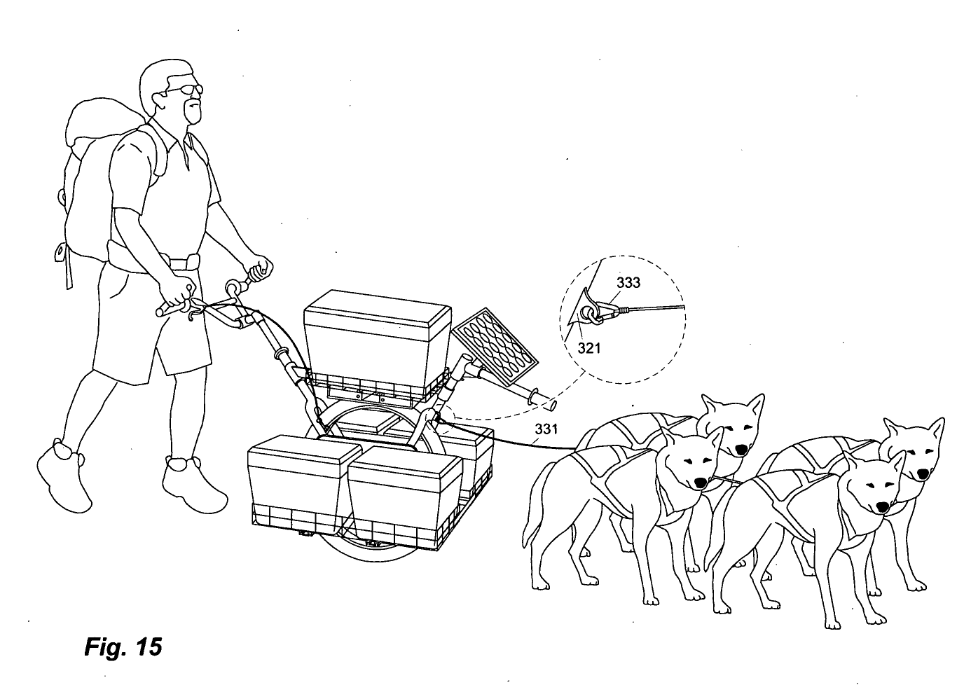

FIG. 15. Perspective view of optional dog team helping pull one embodiment of the present invention using a quick disconnect harness.

### DETAILED DESCRIPTION OF THE INVENTION

The invention is generally described as a cart for transporting equipment and provisions over rough, rugged or uneven terrain, such as a trail. The invention's primary mode of operation is shown in FIG. 1. with the primary operator positioned at the back, and pushing the device, whose center of mass is balanced and completely borne by the wheel (1) and frame (21), by being positioned along the vertical line passing through the middle of the axle (11).

As seen in FIG. 2, the invention is comprised of several core assemblies with each assembly itself being composed of subsidiary members and components. The invention has a single wheel (1), which is attached to a rigid frame assembly (21), lower portions of which form a wheel housing, and upper portions of which provide structures for the attachment of an assembly intended for steering (91) and an assembly intended for assistance in lifting or portage (131). A removable horizontal truss member (71) couples between location points on the back fork (25) and front fork (35) to complete a triangular truss geometry. The frame (21) also provides coupling structures for the attachment of various interchangeable payload supporting platform assemblies, (201) (202) and (303). An optional electrical storage and distribution system assembly (351) can be attached to the bottom side of the horizontal truss (71).

An embodiment of the single wheel (1), is composed of an exterior aluminum rim (3), on which is mounted a tire (5), and which is interlaced to an interior aluminum hub (7) with aluminum spokes (9); however the hub (7), rim (3) and spokes (9) could optionally be comprised of other metallic and/or composite materials. As seen in FIGS. 6a and 6b, the hub assembly (7) includes an axle (11) with a quick disconnect mechanism (13) operated by an activation lever (15), which allows for the easy attachment and removal of the entire wheel assembly from the frame without tools. Alternate embodiments of the rim, spokes and hub could employ a single monolithic block of metallic and/or composite material either cast or machined into a similar geometry, and so provide a mounting surface for the tire. The tire (5), as illustrated, is a rubber pneumatic design, including a rigorously tractive surface, commonly employed on off-road bicycles. Alternate embodiments could have solid, non-pneumatic tires, comprised of alternate natural or synthetic materials, including designs incorporating a tractive surface embedded monolithically into the rim/hub component.

The frame (21) is composed of three core assemblies, of which the first two are lower fork assemblies. The first of these lower fork assemblies is a back fork (25) which is composed of a first single cylindrical down tube (27) to which is rigidly affixed one or two second cylindrical member(s) so that the resulting geometry resembles an inverted Y, defining a left tine (29) and a right tine (30) which diametrically oppose each other on both the right and left sides of the back down tube (27). The second, or front lower fork (35) is similarly constructed with a front down tube (37) and similar left tine (39) and right tine (40).

Each front and back lower fork assembly is oriented in a bilaterally symmetrical manner, with each fork providing a left tine, and each fork providing a right tine, resulting in two left tines and two right tines. Additionally, each fork assembly diametrically opposes the other along the longitudinal axis (direction of travel) of the invention, with each fork assembly being angled diagonally away from each other, relative to the vertical dimension, so that the lower ends of both the left side's front tine (39) and back tine (29) converge at a first center point, thereby forming a first V-shaped structure on the left side of the frame, having each of the two left tines are symmetrically oriented about a first vertical axis which passes through this first center point.

Additionally, both of the right side's front tine (40) and back tine (30) converge at a second center point, forming a second identical V-shaped structure on the right side of the frame, also with the tines similarly oriented symmetrically about a second vertical axis which passes through this second center point.

These two center points directly oppose each other in the transverse dimension, and so define a geometry sufficient to receive each end of the wheel's axle (11), aligning the rim of the wheel so as to allow it to rotate along the longitudinal axis, centered between each side's V-shaped structure. These left and right V-shaped structures thereby form a wheel housing section of the frame (21).

An embodiment of this resulting structure is shown from the left side in detail in FIG. 6a and from the rear in FIG. 6b, as a first fork coupler bracket (43) serving simultaneously as a point of termination and attachment for the left back tine (29) and the left front tine (39), as well as providing a drop-out slot (45) which can receive and attach the axle (11) of the wheel (1), and so rigidly couple forces from the wheel and axle directly into the frame assembly (21). A second fork coupler bracket (44), which is identical to the first fork coupler bracket (43), is similarly configured connecting the right back tine (30) and right front tine (40), and so accepts the right end of the axle (11). An actuator lever (15) on the axle quick release mechanism (13) is pushed downward, rotating a cam and exerting compressional force between the coupler brackets thereby securing the axle of the wheel in place for use.

A second, alternative embodiment is shown in FIG. 6c which allows for a compressionally loaded decoupling between the axle and the frame, which absorbs impact forces from the wheel without transferring them directly into the frame, or on into the load contents. As in the first rigid coupling embodiment, a left fork coupler bracket (51) receives and rigidly attaches the lower ends of the left back tine (29) and the left front tine (39). In addition, a separate movable left axle receiver bracket (53) is held in close proximity to the left fork coupler bracket (51) by a system of slots (55) and guide pins (57), allowing the two brackets to slide past each other in the vertical dimension only. The left fork coupler bracket (51) is mechanically connected to the movable left axle receiver bracket (53) by an assembly comprised of a left spring (61) and left dashpot (63). The spring compresses during the absorption of vertical impact forces and then decompresses back to its normal position while supporting a static vertical load. The dashpot resists any motion in the vertical dimension and so tends to damp, or attenuate, any resonant axle excursions, or bouncing. Additionally a left, threaded nut (65) can be rotated, causing an increase or decrease in the spring force, thereby allowing for the adjustment of the compliance of the system to meet differing load characteristics. Alternate embodiments could do away completely with a mechanical spring by substituting other components that perform similar compressional loading and damping by way of compressing a volume of gas, such as in a typical air shock, etc.

Alternate embodiments of the wheel housing and axle bracket could be composed of a geometry employing a pair of cantilevered members extending downward from the main section of the frame down to the axle's point of attachment. Said alternate cantilevered members could either be rigidly affixed to the frame, or pivot with an alternate compressional fixture to decouple the impact forces of the load from the frame.

In addition to the back fork assembly (25) and front fork assembly (35) previously described, there is a third core component to the frame, which is a rigid member horizontally positioned so as to be longitudinally centered above the wheel, and coupled on its first end to the back fork down tube (27), and coupled on its second end to the front fork down tube (37), thereby creating a triangular truss geometry which reinforces the rigidity of the frame. This horizontal member can be easily attached to, and detached from the down tubes, and so removed from the frame without requiring tools.

An embodiment of the coupling mechanism on the front end of the horizontal member is shown in FIGS. 8a through 8c. In this embodiment the horizontal member is a rigid aluminum T shaped beam (71) which is cut at a diagonal angle on each the back and front ends, thereby matching the angle of the back fork down tube (27) and the front fork down tube (37).

Rigidly affixed to the front diagonal end surface of the T-beam (71) is a hemicylindrical aluminum member (75), which is correlated to a second bilaterally symmetrical hemicylindrical aluminum member (77) which is free. These two hemicylindrical members, when positioned together, result in forming a complete cylinder whose interior diameter is the same as the outer diameter of the front down tube (37). Two keyway channels (79) are cut into the interior circumferential surfaces of both hemicylindrical members, and so form two continuous channels when the hemicylindrical members are mated. Additionally, two metallic rings (81) are rigidly affixed on the front down tube (37) forming two circular keys, in positions which correspond to the two keyway channels (79) cut into the hemicylindrical members.

To engage the coupling, as seen in FIG. 8b, the affixed hemicylindrical member (79) is positioned adjacent to the down tube (37) so that the ring shaped keys (81) engage the keyway channels (79). Next, as seen in FIG. 8d, the free hemicylindrical member (77) is also positioned adjacent to the front down tube (37) in a bilaterally opposed orientation to the fixed hemicylindrical member (75) so that the ring shaped keys (81) also engage its keyway channels (79), and the two hemicylindrical members completely encapsulate a section of the front down tube (37). Threads (85) cut into the external surfaces on both the upper and lower ends of each matched pair of hemicylindrical members receive two knurled threaded nuts (83) which are tightened onto each the upper and lower ends of the resulting cylindrical bracket, and so secure the entire T-beam assembly (71) to the front down tube (37).

As seen in FIG. 8e, this entire process is symmetrically repeated at the opposing end of the horizontal member (71) using a similar fixed hemicylindrical member (76), a similar free hemicylindrical member (78), similar rings and keyway channels (80), external threads (86) and knurled nuts (84), thus allowing the horizontal member (71) to be similarly coupled to the opposing back down tube (27).

Alternate embodiments of these horizontal member's coupling mechanisms may use differing methods for rigidly attaching the affixed hemicylindrical members to the T beam, such as welding, riveted brackets, single unit casting etc.

Alternate embodiments of the entire horizontal truss assembly may incorporate entirely different metallic or nonmetallic materials, methods and geometrical mating surfaces and fixtures to achieve similar secure mechanical coupling and quick release characteristics as the embodiment shown.

The primary operator engages a steering mechanism (91) which is coupled to the frame (21), the height of which can be easily and quickly adjusted for the preferences of the primary operator without requiring tools.

An embodiment of a steering coupler assembly (101) is seen in a detail view of FIG. 3, and includes a cylindrical stem (103), which is inserted into the interior of the back down tube (27). The outer diameter of the stem (103) is very slightly smaller than the inner diameter of the back down tube (27) so that the stem slides easily and smoothly, yet snugly, in a coaxial manner inside the down tube.

The stem (103) is equipped with a pair of diametrically opposed lock pins (105) which protrude outward through diametrically opposed seating holes (109) in the stem body. Each pin is affixed to a spring (107) which holds them in place within the seating holes (109), yet allows finger pressure to push them inward to a position where the outer surfaces of the pins (105) are flush with the outer diameter of the stem (103). The back down tube (27) has several sets of paired diametrically opposing receiving holes (111). This geometry allows the stem's spring loaded pins (105) to protrude outward and through a single set of paired down tube receiver holes (111) when properly aligned with the stem seating holes (109), and so lock the stem securely at a specific height and specific axially rotational position.

Additional locking force can be applied to further secure the stem (103) into position, by tightening a circular quick release compression fitting (115) about the top of the down tube (27), thereby compressing the inner surface of the down tube (27) tightly around the outer surface of the stem (103).

An embodiment of a quick release compression fitting (115) is seen in its detail view in FIG. 3, and is comprised of a strong metallic “C” shaped member (117) whose internal diameter is the same as the outer diameter of the back down tube (27) and so fits snugly around the upper distal end of the down tube (27). The C shaped member (117) allows for the insertion of a bolt (119) which completes the circumferential geometry of the clamp. Additionally, a cam rotating at a pivot point (123) is connected to an actuator lever (121) allows modification of the circumference of the C shaped member (117). When the actuator lever is pulled away from the body of the fitting, the cam is rotated so as to increase the circumference of the C shaped member (117), and so remove any additional compressional force inward upon the down tube (27). This allows for the easy insertion, removal or repositioning of the steering mechanism stem (103) to a location where the lock pins (105) engage a given set of receiver holes (111) in the down tube, thereby selecting an operational height position for the entire steering mechanism assembly (91). To complete the locking process, the compression fitting actuator lever (121) is rotated about its pivot (123) inward until it is adjacent to the body of the compression fitting clamp (117) which reduces the circumference of the clamp thereby exerting additional compressional forces radially inward.

Two diametrically opposed slots (113) are cut into the sidewall at the upper distal end of the down tube (27) resulting in two cantilevered hemicylindrical ends of the down tube (27). This geometry allows the steering coupler's tubular components to be compressed inward by the clamp assembly (115), greatly increasing the frictional coefficient between the outer surface of the stem (103) and the inner surface of the down tube (27).

The combined forces exerted by the interlocking pins (105) along with the compression fitting (115) effectively lock the steering stem (103) to the frame's down tube (27) at a fixed position. Multiple height settings are allowed by providing additional sets of receiver holes (111) in the down tube (27).

Alternate embodiments of a steering coupler (91) may use other metallic and non-metallic materials, and may also utilize alternative geometrical surfaces and fixtures to achieve similar quick disconnect, adjustment and locking behavior.

As seen in FIG. 4, located at the upper distal end of the steering coupler stem (103) is a compression bracket (99) that receives and securely locks the position of the handlebar assembly (93) relative to the coupler stem (103). The handlebar assembly (93) is comprised of a laterally oriented tubular handlebar member (94), a left lateral handgrip (95), a right lateral handgrip (96), as well as a left vertical handgrip (97), and a right vertical handgrip (98). Both sets of lateral and vertical handgrips optimize the ergonomic wrist positions for the primary operator and are detailed in FIG. 7a and FIG. 7b.

The ability for the primary operator to alternate between the lateral and vertical handgrips helps to reduce fatigue induced from repetitive motion, while allowing the primary operator to push and steer, as well as assist in lifting the invention utilizing either set of handgrips when necessary.

An efficient brake assembly (161) is provided to assist the primary operator in controlling the motion of the invention over steeply pitched terrain. A left brake friction pad (167) is affixed to a left brake actuator lever (165), which in turn is pivotally affixed at a position on the back left fork tine (29). A similar right brake friction pad (168) is affixed to a right actuator lever (166), which in turn is pivotally affixed at position on the right back tine (30). The brake is activated by the primary operator by means of a control lever (163) which is positioned near the right horizontal hand grip (96). The brake control lever (163) is connected by a cable (171) to the tops of the actuator levers (165 & 166). As the operator squeezes the control lever (163), a compressional force is transmitted to the tops of the brake actuator levers causing them to rotate inward, thereby compressing the friction pads against the wheel's rim (3) and imparting forces which retard or inhibit rotation of the wheel.

Alternate embodiments of the brake mechanism may use discs or other geometrical surfaces and fixtures which perform similarly in applying retarding forces to the wheel.

When the primary operator cannot easily convey the invention by pushing due to obstacles or terrain characteristics which do not allow the wheel to roll, a process commonly referred to as “portage” is required. This involves having a second person assist the primary operator in lifting the entire invention and its load off the ground and carrying it over the impeding terrain.

To facilitate the second person in lifting the invention, there is a removable portage assist assembly (131) comprised of a portage boom (133) with a portage hand grip (137) positioned at the front of the invention. As seen in FIG. 13, the secondary operator lifts the front of the invention by gripping the portage hand grip (137), while the primary operator lifts the back of the invention using either the horizontal rear hand grips (95 & 96) or the vertical rear hand grips (97 & 98), and together they carry the invention over terrain or obstacles that preclude using the wheel.

As seen in FIG. 3, the front portage boom (25) is coupled to the frame (21) in a manner similar to that of the rear steering mechanism by means of a portage coupler assembly (139) which is comprised of a the following; the portage boom (133) terminates into a fixed angle connector bracket (135) which is rigidly affixed to a portage connecting member or stem (141), which is inserted into and slides down inside the front down tube (37). The outer diameter of the portage coupling stem (141) is slightly smaller than the inner diameter of the front down tube (37), so that the portage stem can slide easily and smoothly, yet snugly when inserted into the front down tube (37).

The portage stem (141) has a pair of diametrically opposed lock pins (143) which protrude outward through diametrically opposed seating holes (147) in the stem body. Each pin is affixed to a spring (145) which holds them in place within the seating holes (147), yet allows finger pressure to push them inward to a position where the outer surfaces of the pins (143) are flush with the outer diameter of the stem (141). The front down tube (37) has a set of diametrically opposing receiving holes (149). This geometry allows the stem's spring loaded pins (143) to protrude outward and through the set receiver holes (149) when properly aligned with the stem seating holes (147), and so lock the portage stem securely. The secondary operator can then use the portage boom to assist in lifting and carrying the invention.

The portage assist boom (133) can also be rotated into a retracted position (151) by releasing the lock pins (143), then rotating the portage coupler stem (141) 180 degrees and reengaging the lock pins (143). This retracted position (151) may be more suitable when portage is not required.

Alternate embodiments of the portage coupler (139) may use other metallic and non-metallic materials, and may also utilize alternative geometrical surfaces and fixtures to achieve similar quick disconnect, retraction and locking behavior.

Alternate embodiments of the portage assembly (131) may use other materials, structures and fixtures to provide similar functionality of easy removal and reconfiguration for a member to facilitate lifting and carrying the invention.

Payload bearing platform assemblies, of multiple and varying designs, can be connected to the frame by engaging the complimentary surfaces of platform coupler mechanisms and platform joint mechanisms. These coupler mechanisms allow interchanging differing platform designs quickly and easily without requiring tools, thus allowing the invention to readily adapt to a broad spectrum of load requirements and conditions.

A first load bearing platform assembly positions its load contents on the left side of the frame at a height which allows for optimum ground clearance and with the center of gravity positioned vertically at approximately the axle level.

An embodiment of a first load bearing platform joint coupler mechanism is seen in FIGS. 9a & 9b, and employs a stamped metal hanger bracket (217) to which a front connecting girder (205) and a back connecting girder (211) are attached. Both connecting girders (205) & (211) encompass an L shaped design comprising an upper vertical section, a 90 degree bend, and a lower horizontal section. Two front bolts (209) and two back bolts (215) securely affix the upper vertical section of each of the connecting girders to their respective mount points on the hanger bracket (217).

Additionally, the hanger bracket (217) has an edge radius (219) which runs its entire perimeter stamped into it so as to reinforce the rigidity of the bracket. Additional reinforcement ridges (221) are also stamped at multiple strategic locations within the bracket also contributing to its reinforcement and rigidity.

As seen in FIG. 4, a first load supporting platform (203) is then attached to the lower horizontal sections of each the two connecting girders (205) & (211) using front fasteners (207) and back fasteners (211). The resulting composite assemblage of hanger bracket, girders and load platform produces a strong, yet light, self contained assembly (201) which is then engaged to a first platform coupler which is permanently affixed to the left front fork tine (39) by a welded bracket (233), and left back fork tine (29) by a welded bracket (235).

As seen in FIGS. 9a and 9b, the stamped metal receiver bracket (231), which is a slightly larger version of its respective platform joint, or hanger bracket (217), has its internal concave surfaces matched in a complimentary manner to the outer convex surfaces of the hanger bracket (217), and is designed so as to completely encapsulate the first hanger bracket (217) when coupled. To accomplish this complimentary geometry, the receiver bracket (231) also has a continuous perimeter edge radius (237) and reinforcing ridges (239) stamped at positions so as to match directly with the curved surfaces of its respective hanger bracket (42).

As seen in FIGS. 5a & 5b, these complimentary coupler bracket fixtures are engaged by first positioning the load platform assembly (201) alongside the frame (21). Next, the load platform assembly (201) is lifted and then rotated outward and upward along the hanger bracket's (217) top horizontal edge. The top edge of the hanger bracket (217) is then inserted into the upper concave area of the receiver bracket (237), in and behind a top retainment lip (249) included on the receiver bracket (231). This retainment lip (249) then restrains the top edge of the hanger bracket (42) in position while the remainder of the load platform assembly (201) is then rotated downward, thus engaging all complimentary curved surfaces of the two brackets into a mated position.

In addition to the coupling surfaces stamped into each bracket, the receiver bracket (231) also has two sturdy load bearing pins which protrude forward into the concave area. Each of these pins then penetrates a corresponding receiver hole in the hanger bracket (217) as the load platform assembly (201) is rotated downward into a coupled position. The front pin (241) thus engages the front receiver hole (223), and the back pin (243) engages the back receiver hole (225).

The engagement of these two pins (241 & 243) into their two corresponding receiver holes (223 & 225) encompasses the main load bearing fixture for transmitting forces between the two brackets. The engagement of the brackets' corresponding edge radius surfaces (219 & 237) and reinforcement ridges (221 & 239) ensures that the pins are securely and fully inserted into, and retained by, the receiver holes.

The final step in coupling the first load platform assembly (201) to the frame (21) is to engage two quick release locking fasteners which retain the hanger bracket (217) securely within the receiver bracket (231), and so maintain the engagement of all interlocking surfaces. The first quick release locking fastener (227) is located at the front of the hanger bracket (217) and a second quick release locking fastener (229) is located at the back of the hanger bracket (217). Each quick release locking fastener requires only ninety degrees, or one quarter of a turn, to lock or unlock, and each is retained in position, or captive, while not engaged so as to not lose them.

To disengage the first load bearing platform assembly (201) from the frame (21), the reversal of steps for the engagement process is required. The quick release locking fasteners (227 & 229) are each rotated counter clockwise one quarter turn, thereby releasing them. This allows the entire load platform assembly (201) to then be rotated outward and upward, thus disengaging the two receiver bracket (231) load bearing pins (241 & 243) from their respective hanger bracket (217) receiver holes (223 & 225), as well as decoupling all other correlated stamped surfaces. At a sufficient angle of rotation, the entire platform assembly (201) is pulled out and away from the frame, disengaging the top edge of the hanger bracket (217) from behind the retainer lip (249) of the receiver bracket (231), thereby freeing the entire load platform assembly (201) from the frame (21).

A second load platform assembly (202) is identical to the first load platform assembly (201) except that it is positioned in a bilaterally symmetrical location on the right side of the frame (21). A second platform coupler receiver bracket (232) and a second platform joint hanger bracket (218), which are also identical to the first platform coupler receiver bracket (231) and first platform joint hanger bracket (217) respectively, are also positioned in similar, bilaterally symmetrical locations on the right side of the frame (21).

The first and second load platforms and load platform couplers therefore comprise a matched pair of identical symmetrical structures.

Alternate embodiments of side load platforms and coupling systems could use other metallic and/or non metallic materials, as well as utilizing alternative geometrical surfaces and fixtures which achieve similar quick coupling, decoupling and load bearing capabilities.

Additionally, auxilliary stabilization members can also be employed to interconnect the bottoms of each the left and right load platforms (201 & 202) at both the front and back inner corners, to further increase the overall rigidity and stability of the platforms under load. These stabilization devices counteract the tendency of the cantilevered load platforms (201 & 202) to rotate axially about the engaged couplers while under load, by transmitting diametrically opposed compressional forces back into each other, thereby counterbalancing them. As such, the forces causing the left load platform to rotate to the right are met and balanced by the forces causing the right load platform to rotate to the left, with the result that each platform reinforces its partner and all rotational forces are cancelled.

An embodiment of a first auxiliary load platform stabilizer is shown in FIG. 4 comprised of a rigid horizontal bar (271) which is engaged between the front inner corners of both the left load platform (201) and right load platform (202). To retain the bar (271) in position, a first quick disconnect locking fastener (273) is located on the left end of the bar (271), and a second front quick disconnect locking fastener (274) is located on the right end of the bar (271). The shafts of each locking fastener (273 & 274) are inserted into and retained by corresponding receivers, which are affixed to the front inner corner of each load platform assembly (201 & 202). The first receiver (279) is located on the front inner corner of the left load platform assembly (201) and the second receiver (280) is located on the front inner corner of the right load platform assembly (202).

A second auxilliary load platform stabilizer, shown in FIG. 5b, is similarly deployed, connected between the back inner corners of the load platforms (201 & 202), which is comprised of a second rigid horizontal bar (251), a left quick disconnect locking fastener (253) and receiver (259), and a right quick disconnect locking fastener (254) and receiver (260).

These quick disconnect locking fasteners are similar to those previously mentioned which secure the load platform coupler brackets while engaged. Each locking fastener, as detailed in FIG. 4, is typically comprised of a handle (273) connected to a shaft (275) in which bayonet pins (277) are embedded at the distal end. The shaft protrudes through holes in the members which are to be joined, and on into a receiver bracket barrel (279) into which are cut slots (283) to guide and lock the bayonet pins (277).

Engaging, or locking the fastener requires only ninety degrees of rotation, or one quarter turn, of the handle (273) in a clockwise direction. To disengage the lock requires a corresponding ninety degree rotation of the handle (273) in the counterclockwise direction. The fastener handle (273), and shaft is retained by, or captive to, the member they affix, so that when disengaged, they do not fall out and become lost. This captivity also correctly aligns the shaft (275) for insertion into the receiver barrel (283) while engaging the fastener. After engagement, the handle can rotate to flip down, which minimizes its height, so as to not be obtrusive while unneeded.

Alternative embodiments of auxiliary stabilizer members could use other metallic or non metallic materials, as well as utilizing alternative geometric surfaces and fixtures to accomplish similar reinforcement and rapid connection and disconnection behavior based on the specific design of the load platform.

A third load bearing platform assembly (301), which differs from the first (201) and second (202) load platform assemblies, positions its load generally directly above the wheel (1) and generally between the front down tube (37) and the back down tube (27).

An embodiment of this third, or upper, load bearing platform assembly (301) is shown in FIG. 4 as a general purpose wire frame basket (303) with a stamped metal floor bracket (309) which is securely and rigidly fastened directly to horizontal truss member (71) using fasteners (305) which engage mounting holes (307) located in the top surface of the horizontal truss T-beam (71).

Since, as previously described, the horizontal T-beam truss (71) can be easily attached or detached from the frame without needing tools, alternate specialized designs for upper load platforms, which are also each affixed to a T-beam assembly (71), can also be readily interchanged.

Alternative embodiments of either the top load platform or horizontal truss may use other metallic and/or non-metallic materials, as well as employing alternate geometrical surfaces, fixtures or features to achieve similar interchangeable and load bearing behavior.

As can be seen, the ability to quickly disengage and quickly reengage alternate sets of either side or top platforms with differing designs, allows the invention to adapt very easily to a wide array of load contents, requirements and conditions.

An additional advantage is that, when all core assemblies have been removed, the invention requires much less contiguous space to store and transport.

When climbing steep slopes while fully laden, the gross weight of the invention may require more motive power than the primary operator can comfortably contribute, even though the terrain allows the wheel to roll freely. At such times supplemental motive power is required. As seen in FIG. 3, a specifically positioned coupling (321) easily allows sources of supplemental motive power to be quickly connected and disconnected, and so assist the primary operator in conveying the invention. This supplemental force coupling (321), comprised of a robust ring, is permanently fastened on the leading side of the lower front down tube (37), and allows the connection of one or more handheld lanyard assemblies (323).

As seen in FIG. 14, an embodiment of such a lanyard (323) consists of a quick disconnect hooking mechanism (329), commonly referred to as a carabiner, connected by a light yet sturdy cord (327) to a handgrip (325) which is angled to provide a more comfortable grip to the assisting person.

On extremely steep grades multiple lanyards, each utilizing a different length of cord, can allow two or more assistants to be concurrently connected and assist the primary operator by pulling the invention together in tandem. The multiple lengths of cord permit all connected assistants to continue walking in single file, directly in front of the invention, which is often necessary on narrow trails. Assistants can use either hand to grasp the handgrip (325), and may easily swap hands as conditions change or fatigue sets in.

When the grade of the slope decreases and no further supplemental motive power is required, the carabiners (329) allow quick and easy disconnection, thereby returning the invention to its primary mode of operation. The assistants may continue to carry the lanyards (323) and quickly recouple to the invention as needed, without causing unnecessary delay by doing so.

A second embodiment of the supplemental power connections may include a traditional harness (331) that allows a dog team or small dray animal to be connected. An embodiment of this type is shown in FIG. 15 utilizing a more robust carabiner (333) capable of transmitting the unified motive force of the entire dog team.

Additional alternate embodiments of devices to connect supplemental motive power to the invention may include different materials, fixtures and features to provide similar quick connection/disconnection, and force coupling behavior.

In each of the previously described cases, while sources for supplemental motive power are connected, the opportunity arises for the induction into the frame (21) of both, undesirable laterally directed forces, together with the desirable longitudinal forces which assist in pulling the invention in the forward direction. Such induced lateral forces conflict with the steering forces being imparted by the primary operator, degrading the maneuverability of the invention and causing fatigue and other counterproductive effects.

The specific geometric location of the supplemental motive force coupling (321) minimizes these undesirable lateral effects. Therefore, the maneuverability of the invention is unaffected while supplemental motive power is connected, resulting in no reduction in the primary operator's ability to negotiate obstacles or perform tight pivoting turns.

An accurate electronic odometer (341) is included which provides valuable trip distance, travel period duration and arrival time data. This information can be used to swap out operators, plan breaks, prevail in wagers, etc. A magnetic sensor is attached to one of the fork tines and detects a magnet attached to one of the spokes as it passes. The computer then counts revolutions and computes lineal distance as a function of the diameter of the wheel (1).

An optional self contained electrical storage and distribution system (351) can also be included to supply electical power at various voltages and frequencies to any additional electronic instruments which may be needed, such as computers, GPS receivers, recording and communications equipment, etc.

An embodiment of this system includes four storage batteries (353) and the associated circuitry and connectors (355) needed to charge the batteries from multiple and various sources of electric power, including 110 VAC and 12 VDC sources. These sources include traditional utility provided power, as well as photo voltaic solar panels (357) which may be connected in tandem using multiple connectors (359). The solar panels can be of either a rigid or a flexible design, facilitating many options for attachment to the invention during travel or at rest.

The electrical system assembly (351) can be affixed permanently, or as a removable assembly, to the horizontal truss member (71) above the wheel (1), and below the third load platform assembly (301).

Alternate embodiments of the electrical system could provide additional capacities and features specifically matched to the needs of the equipment conveyed. Additional sources of renewable electrical energy could be provided, including petro-chemically powered, hydro powered, and human powered electric generators, etc.

The envisioned embodiments of the invention indicate that, while properly loaded, it is an inherently stable vehicle which can be stopped and parked by simply leaning it to either side, or to the front or back, and locking the brake. This is detailed in FIGS. 10a through 10d. If a precise orientation while parked is required, the requisite stands and fixtures could be added to a load platform design. For example, the invention may need to be level for precisely aiming satellite or tower based communication antennae, laser range finders, transoms, etc.

It can be seen that the extensibility and adaptability of the invention allows for there to be very, very many different customized configurations. Two simple specific examples of specialized configurations are included here.

The first example shown in FIGS. 11a and 11b details a specialized configuration where the side load bearing platforms (373) are adapted to easily carry four commercially available ice chests, while the third load bearing platform (371) has specific fixtures to securely carry multiple types of firearms while allowing easy access to any specific weapon. A configuration of this type would be optimized for hunting or competition shooting.

A second example shown in FIGS. 12a & 12b details a custom configuration where the two side load bearing platforms (375) are specialized to carry four standard five gallon plastic buckets, while allowing easy removal of any bucket to fill or access its contents. Additional brackets provide fixtures (377) for attaching shovels or other tools. The third top load bearing platform (379) is customized with fixtures that securely carry a chainsaw and fuel. This configuration would be optimized for trail construction or maintenance.

What is claimed is:

1. An all terrain cart, comprising:
a frame having a wheel housing with a steering coupler and a portage coupler, a steering connecting member with a first end and a second end engaged to the steering coupler, and a portage connecting member with an assistance end and a wheel housing end engaged to the portage coupler, wherein the wheel housing has a center point with a vertical axis passing therethrough, and further wherein the first end projects away from the vertical axis in a first direction and the assistance end projects away from the vertical axis in a second direction opposite the first direction;
a steering mechanism coupled to the first end;
a front boom having a body with a grip end and a portage connector end distal the grip end, wherein the portage connector end is engaged to the assistance end and the grip end extends away from the vertical axis;
a first load bearing assembly having a first hanger bracket with a first hanger bracket geometry;
a second load bearing assembly having a second hanger bracket with a second hanger bracket geometry;
a single wheel rotatably engaged to the wheel housing; and
wherein the wheel housing has a first side including a first receiver bracket with a first receiver bracket geometry complementary to the first hanger bracket geometry and a second side including a second receiver bracket with a second receiver bracket geometry complementary to the second hanger bracket geometry, and further wherein the first load bearing assembly is removably engaged to the first side of the wheel housing, via the first hanger bracket and the first receiver bracket, and the second load bearing assembly is removably engaged to the second side of the wheel housing, via the second hanger bracket and the second receiver bracket.

2. The cart of claim 1, wherein the portage connector is rotatably engaged to the assistance end to allow the grip end to rotate towards the vertical axis.

3. The cart of claim 1, wherein the single wheel has a rim, the cart further comprising:
a brake assembly including a brake controller mounted on the steering mechanism and a brake actuator mounted on the wheel housing, wherein the brake actuator is disengagedly coupled to the rim and operably connected to the brake controller.

4. The cart of claim 1, further comprising:
an odometer engaged to the steering mechanism, wherein the odometer includes a sensor remotely mounted proximate the single wheel.

5. The cart of claim 1, further comprising:
one or more electric storage batteries coupled to the frame.

6. The cart of claim 5, further comprising:
electrical instrumentation engaged to the steering mechanism and the one or more batteries.

7. The cart of claim 1, further comprising:
a solar panel engaged to the frame.

8. The cart of claim 1, further comprising:
a third load bearing assembly engaged to and spanning between the steering connecting member and the portage connecting member.

9. The cart of claim 8 wherein the third load bearing assembly is centered over the single wheel.

10. An all terrain cart, comprising:
a rigid frame having a wheel carrier section with first and second sides, a back down tube coupled to the wheel carrier section and having a first end distal the wheel carrier section, a front down tube coupled to the wheel carrier section and having an assistance end distal the wheel carrier section, a first platform joint engaged to the first side of the wheel carrier section and having a first platform geometry, and a second platform joint engaged to the second side of the wheel carrier section and having a second platform geometry, wherein the front and back down tubes diverge as the front and back down tubes extend away from the wheel carrier section;
a single wheel operably engaged to the wheel carrier section;
a supplemental boom having a frame connector end coupled to the assistance end and a grip end distal the frame connector end, wherein the grip end projects away from the rigid frame;
a steering mechanism coupled to the first end of the back down tube;
a first interchangeable platform having a first platform coupler shaped to complement the first platform geometry, wherein the first platform coupler is detachably engaged to the first platform joint; and
a second interchangeable platform having a second platform coupler shaped to complement the second platform geometry, wherein the second platform coupler is detachably engaged to the second platform joint.

11. The cart of claim 10, wherein the steering mechanism is slidably coupled to the first end of the back down tube.

12. The cart of claim 10, wherein the frame connector end of the supplemental boom is pivotally engaged to the assistance end to permit the grip end of the supplemental boom to swivel around towards the rigid frame.

13. The cart of claim 10, further comprising:
a solar panel coupled to the supplemental boom.

14. The cart of claim 13, further comprising:
one or more electric storage batteries coupled to the rigid frame and operably connected to the solar panel.

15. The cart of claim 10, wherein the rigid frame has top section above the wheel carrier section, the top section includes a third platform joint with a third platform geometry, the cart further comprising:
a third interchangeable platform having a third platform coupler shaped to complement the third platform geometry, wherein the third platform coupler is detachably engaged to the third platform joint.

16. The cart of claim 10, further comprising:
an odometer coupled to the steering mechanism.

17. A rough terrain cart, comprising:
a single wheel with a hub assembly;
a first frame member having an elongated body with a lower first frame member coupled to the hub assembly and extending radially therefrom;
a second frame member having a first attachment location, an elongated body with a lower second frame member coupled to the hub assembly and extending radially therefrom;
a truss positioned over the single wheel, the truss coupled to and extending between the elongated body of the first frame member and the elongated body of the second frame member;
a steering mechanism engaged to the body of the first frame member;
a supplemental motive force coupling engaged to the body of the second frame member at a first location, wherein the cart has an operating orientation, and further wherein horizontally-oriented forces applied to the supplemental motive force coupling, at the first attachment location, do not alter the operating orientation.

18. The cart of claim 17, further comprising:
an auxiliary boom coupled to the second frame member and projecting away from the single wheel.

19. The cart of claim 18, wherein the auxiliary boom is rotatably coupled to the second frame member to permit the auxiliary boom to swivel relative to the second frame member.

20. The cart of claim 17, wherein the truss has an upper section, the cart further comprising:
a supplement load bearing platform engaged to the upper section of the truss.
